(19) United States
(12) Patent Application Publication
(10) Pub. No.: US 2020/0089026 A1
(43) Pub. Date: Mar. 19, 2020

(54) SUNGLASS FLOTATION DEVICE

(71) Applicant: 4 KEEPZ LLC, Raleigh, NC (US)

(72) Inventor: Craig T. Mickels, Raleigh, NC (US)

(73) Assignee: 4 KEEPZ LLC, Raleigh, NC (US)

(21) Appl. No.: 16/134,148

(22) Filed: Sep. 18, 2018

(51) Int. Cl. G02C 11/00; G02C 7/10; G02C 5/14

(52) U.S. Cl. CPC G02C 11/00; G02C 5/14; G02C 7/10

(57) ABSTRACT

A sunglass flotation device is described that attaches on the inside temple and is not viewable by others.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a sunglass flotation device to prevent their loss in water. In particular, it relates to a device for flotation of sunglasses that is more esthetically pleasing and not easily visible while still fully functional.

### Description of Related Art

There is a substantial problem that occurs at the beach very frequently. Most people wear sunglasses at the beach, but losing them is a problem. One of the ways people lose sunglasses is they accidently drop them in the water at a place where they are not retrievable, e.g. hit by a wave or fall off a boat.

There have been several different approaches to either keep the sunglasses out of the water, such as eyeglass straps, and there are numerous devices to attach to the sunglasses to help them float in the water thus making them retrievable. All the attachable devices are positioned usually around the temple pieces and are of a size or shape that a large percentage of the attachment is visible on the glasses. While not very attractive, most people at the beach don't mind. However, outside of the beach they detract severely from the use so either you have to have a separate pair of glasses or you have to remove the flotation device before you can wear them. Most of the devices made are designed to add and remove the flotation device such as wrapping around the temple. Neither is a very satisfying situation for the user since it's easy to forget to bring and are costly.

### BRIEF SUMMARY OF THE INVENTION

The present invention relates to the discovery that if a piece of flotation foam or other material is positioned on the inside surface of the temple behind the temple hinge which is no wider than the height of the temple then the flotation device works without the flotation device being visible to anyone and feeling uncomfortable for the user.

Accordingly, in one embodiment, there is a float for positioning on the inside temple behind the temple hinge of a pair of glasses comprising positioning a buoyant material on the inside surface of the temple piece behind the temple hinge of a height and length designed to hide behind the temple piece such that it is not seen by others when worn by a user.

In another embodiment, there is a method of preventing a pair of glasses from sinking once dropped in water comprising:
positioning a buoyant material on the inside surface of a temple piece behind a temple hinge of a height and length designed to hide behind the temple piece such that it is not seen by others when the glasses are worn by a user.

### BRIEF DESCRIPTION OF THE DRAWINGS

FIG. 1 is a side view of the buoyant material.

FIG. 2 is a perspective view of the buoyant material on the temple of a pair of glasses.

FIG. 3 is a close up of the inside of a temple piece showing the buoyant material.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “float” refers to a material of sufficient buoyancy that when the material is adhered to the inside temple surface of a pair of glasses, it is of sufficient buoyancy that it will support the weight of the glasses when floating. The float is of a size that when placed on the inside temple piece of a pair of glasses such that the height and length of the float hides behind the temple such that it is not seen or felt by others when the glasses are worn by a user of the glasses. In one embodiment, there are a plurality of floats attached to the glasses.

As used herein, the term “positioning” refers to placement of the one or more of floats on the inside temple surface of a pair of glasses. In one embodiment, there is at least one float on each inside temple of the present invention. The float is held in position by use of an adhesive on the surface of the float that comes in contact with the inside temple piece. Adhesives for holding floats are well known as are adhesives compatible with the temple pieces of a pair of glasses.

As used herein, the term “inside temple” refers to the surface of the temple of a pair of glasses that is closest to the users head.

As used herein, the term “temple hinge” refers to a flexible hinge that connects the temple to the body of the glasses which is designed to fold the temples up against the inside of the body of the glasses.

As used herein, the term “glasses” refers to any type of glasses having a pair of temples including reading glasses, sunglasses, and vision glasses.

As used herein, the term “buoyant material” refers to the material the float is made of. Such material consists of a material that will not only float but will support weight and still float. Examples of such material include but are not limited to polyethylene foam.

As used herein, the term “earpiece” refers to the part behind the temple designed to wrap around the ear of the user for holding the glasses in place on a user's head.

### DRAWINGS

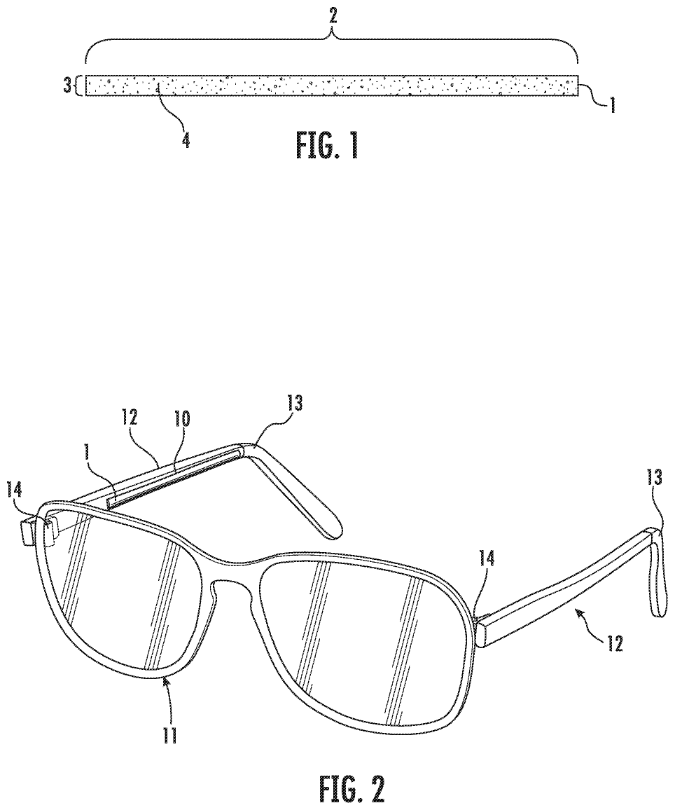

Now referring to the drawings, FIG. 1 is a drawing of a float 1 of the present invention. Float 1 is of a length 2 and width 3 such that it will fit on the inside surface of the glasses it will be utilized on. The float 1 has an adhesive 4 positioned along the length and width of one side of the float 1 for the purpose of stilling the float to the inside temple.

In FIG. 2, the float 1 is shown mounted on glasses. Glasses 11 (regular, reading, or sunglasses) have inside surface 10 of temple 12 wherein the float is positioned. Also shown is earpiece 13 and hinge 14. Float 1 is positioned on the inside surface 10 of the temple. In this view, only one float is shown but there could be a plurality of floats on both temples.

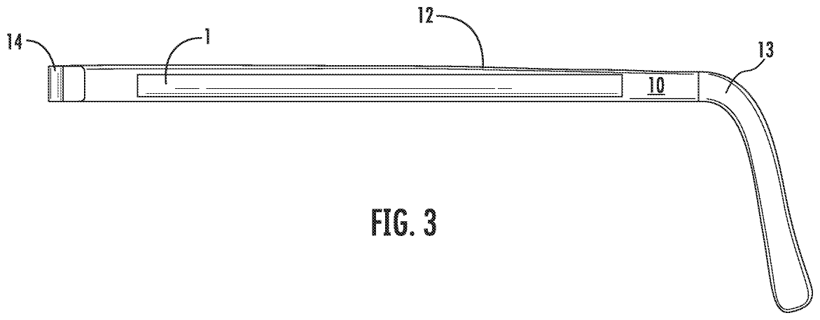

FIG. 3 is a blown up side view of the inside surface of a temple. All the numbers are the same as in previous figures.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A float for positioning on the inside temple behind the temple hinge of a pair of glasses comprising positioning a buoyant material on the inside surface of the temple piece behind the temple hinge of a height and length designed to hide behind the temple piece such that it is not seen by others when worn by a user.

2. The float according to claim 1 which is positioned on the inside temple of a pair of glasses.

3. The float according to claim 2 wherein the glasses are sunglasses.

4. The float according to claim 2 which is positioned between the temple hinge and an earpiece.

5. The float according to claim 1 wherein the buoyant material is polyethylene foam.

6. The float according to claim 1 wherein there is adhesive on the buoyant material design to hold the buoyant material on the inside temple.

7. A method of preventing a pair of glasses from sinking once dropped in water comprising:
positioning a buoyant material on the inside surface of a temple piece behind a temple hinge of a height and length designed to hide behind the temple piece such that it is not seen by others when worn by a user.
